(19) United States
(12) Patent Application Publication
(10) Pub. No.: US 2023/0170756 A1
(43) Pub. Date: Jun. 1, 2023

(54) Electric Rotating Machine, Electric Motor, or Liquid Pump with Air Gap Sleeve

(71) Applicants: Siemens Aktiengesellschaft, München (DE); Siemens Mobility GmbH, München (DE)

(72) Inventors: David Finck, Forchheim (DE); Felix Ntourmas, Erlangen (DE); Christian Seidel, Baiersdorf (DE); Andreas Grünthaler, Nürnberg (DE); Olaf Körner, Nürnberg (DE); Wolfgang Wetzel, Herzogenaurach (DE)

(73) Assignees: Siemens Aktiengesellschaft, München (DE); Siemens Mobility GmbH, München (DE)

(21) Appl. No.: 17/921,571

(22) PCT Filed: Apr. 26, 2021
(86) PCT No.: PCT/EP2021/060873

§ 371 Date: Oct. 26, 2022

(30) Foreign Application Priority Data
Apr. 27, 2020 (DE) 10 2020 205 287.5

(51) Int. Cl. H02K 5/02; F04B 17/03; F04D 13/06; C08J 5/24; C04B 35/80

(52) U.S. Cl. CPC H02K 5/02; F04B 17/03; F04D 13/0626; C08J 5/243; C08J 5/246; C04B 35/80; C08J 2423/06; C08J 2467/02; C04B 2235/5248

(57) ABSTRACT

Various embodiments of the teachings herein include a canned electrical rotating machine or liquid pump. The machine or pump may include a can made of a first material. The first material comprises, at least in a proportion of more than 50% by weight, a composite material with high-modulus or ultrahigh-modulus (HM/UHM) carbon fiber reinforcement.

### CROSS-REFERENCE TO RELATED APPLICATIONS

This application is a U.S. National Stage Application of International Application No. PCT/EP2021/060873 filed Apr. 26, 2021, which designates the United States of America, and claims priority to DE Application No. 10 2020 205 287.5 filed Apr. 27, 2020, the contents of which are hereby incorporated by reference in their entirety.

### TECHNICAL FIELD

The present disclosure relates to electrical machines. Various embodiments of the teachings herein include canned electrical rotating machines, electric motors, and/or liquid pumps.

### BACKGROUND

Increasing the power density of electric motors is of ever greater importance in the electrified field of mobility, for example in electrically driven vehicles such as buses, cars, utility vehicles, in trains and ships, and aircraft, because more powerful motors can save weight. There is therefore increasing attention on liquid-cooled electric motors.

A factor that determines the dimensions in respect of the electrical power density of an electric motor is the waste heat produced, with the associated problems. One problem is, for example, the failure of the polymeric insulation of the winding coils in the laminated stacks of the stator of each electric motor.

Therefore, the maximum temperature in the stator winding in the electric motor is also typically a particularly critical aspect in the case of development of higher power densities.

The reason for the trend toward liquid cooling lies in the higher waste heat flow achievable by means of liquid cooling, by comparison with gas-air cooling. In general, liquid cooling of an electric motor is implemented on the outside of the stator because the interface to the rotor on the inside of the stator otherwise has to be sealed.

In general, the channels for the liquid cooling are thus on the outside of the stator. A problem is that the liquid-cooled cooling rings are on the outside of the laminated stack; therefore, this first has to be traversed completely by the heat flow in radial direction. As of recently, there are thus also electric motors having liquid cooling on the inside and outside of the stator.

These electric motors include what is called a can. The can surrounds the rotor of an electric motor, generator or a liquid pump, and separates the cooling fluid in the stator region from the rotating rotor or the rotating pump. The aim in the development of the can is to achieve a minimum wall thickness, since electrical losses from the electrical machine are thus kept to a minimum, or reduced.

Various boundary conditions should be observed in component development of cans. The can has the function of providing a space that can be flooded with cooling fluid for the laminated stack of the stator. The can is present between the rotor and the stator and experiences local hotspots. It is therefore desirable for the material to have thermal conductivity in order to avoid excessive thermal material stress on the can.

Alternating magnetic fields as occur in extreme size in the air gap of an electric motor induce an eddy current in electrically conductive materials. The eddy current in turn generates a magnetic field in the opposite direction to the magnetic field that causes it. Moreover, an induced eddy current leads to rapid heating of the component. It is therefore undesirable in several ways for a can to consist of an electrically conductive material. Therefore, reinforced composite materials, including ceramic and/or glass-ceramic composite materials, are used for cans both in pumps and in electric motors.

A can has to have a certain minimum thickness. Factors that determine the dimensions in respect of the outside pressure on the can are primarily not so much the accelerations resulting from the application, but rather the static pressure with which the cooling system is operated. In order to achieve a particular target volume flow rate in the system, a particular pressure is applied, which then bears on the can.

Cans that are too thin collapse under the above-described pressure, the failure being described by the phenomenon of warping. In the event of failure, deformations in the form of a wavefront are typically formed on the tube. However, the reinforced composite materials that have been used to date as composite material for cans and comparable applications in tubes under pressure stress have extremely low thermal conductivity and low warpage resistance on account of low stiffness in circumferential direction.

WO 2009/040308 discloses that carbon fibers are unsuitable for use for production of cans owing to their intrinsic electrical conductivity. This is more particularly because the carbon fiber in the can still has too high an electrical conductivity that would too significantly lower the efficiency on account of the eddy currents induced.

### SUMMARY

The teachings of the present disclosure describe a material for production of a can for an electrical rotating machine, such as an electric motor or a generator, or a liquid pump, or another tube under pressure stress, which improves on the low thermal conductivity and/or low warpage resistance of the materials and composite materials used to date and/or shows improved thermal conductivity over the materials used to date. For example, some embodiments of the teachings herein include a canned electrical rotating machine or liquid pump, in which the can material comprises, at least in a proportion of more than 50% by weight, an HM/UHM composite material with high-modulus “HM” or ultrahigh-modulus “UHM” carbon fiber reinforcement.

In some embodiments, the HM/UHM carbon fibers are in elongated form in the HM/UHM composite material.

In some embodiments, the HM/UHM carbon fibers in the HM/UHM composite material are at least partly in the form of a UD layer.

In some embodiments, the HM/UHM carbon fibers in the HM/UHM composite material are at least partly in unidirectional form.

In some embodiments, the HM/UHM carbon fibers in the HM/UHM composite material are at least partly in the form of an endless roving.

In some embodiments, the HM/UHM carbon fibers in the HM/UHM composite material are at least partly in the form of pitch-based fibers.

In some embodiments, the pitch-based HM/UHM carbon fibers in the HM/UHM composite material are at least partly in the form of hard coal tar pitch-based HM/UHM carbon fibers.

In some embodiments, the matrix material present in the HM/UHM composite material is a thermoset.

In some embodiments, the matrix material present in the HM/UHM composite material is a thermoplastic.

In some embodiments, the matrix material present in the HM/UHM composite material is a ceramic.

In some embodiments, the HM/UHM carbon fibers in the HM/UHM composite material are present at least in a proportion by volume—based on 100% by volume of the HM/UHM composite material—in the range from 35% by volume to 80% by volume.

In some embodiments, the can comprises a material combination of an HM/UHM composite material and a glass, aramid, polymer and/or ceramic fiber composite material.

In some embodiments, the can comprises a material combination of an HM/UHM composite material and an aramid, polypropylene and/or polyethylene terephthalate fiber composite material.

In some embodiments, the can comprises a material combination of an HM/UHM composite material and a polypropylene fiber composite material.

In some embodiments, the can comprises a material combination of a UHM composite material and a polyethylene terephthalate fiber composite material.

### BRIEF DESCRIPTION OF THE DRAWINGS

FIG. 1 shows the measured component temperatures in an electric motor;

FIG. 2 shows a conventional can according to the prior art; and

FIG. 3 shows a can incorporating teachings of the present disclosure.

### DETAILED DESCRIPTION

Some embodiments of the teachings herein include canned electrical rotating machines and/or liquid pumps in which the can material comprises, at least in a proportion of more than 50% by weight, a composite material having high-modulus carbon fiber reinforcement.

HM/UHM carbon fiber reinforcement, when used as composite material for cans of liquid-cooled electric motors and/or generators, contrary to expert opinion, does not generate induced eddy currents that lower the efficiency of the electrical machine, but rather improves and increases the efficiency and lifetime of the electrical rotating machine via thermal durability and/or warpage resistance. This is especially true when the high-modulus (HM) or ultrahigh-modulus (UHM) carbon fibers are present with a preferential orientation in the fiber composite material and the can is produced by winding in this preferential orientation and transverse to the axial direction of the rotor.

The cans reinforced with HM/UHM carbon fibers do have low compressive strength and shear strength, but are nevertheless suitable for reinforcement of tubes under pressure stress, such as the can of a liquid-cooled electrical rotating machine or a liquid pump. There has to date been a prejudice in science that composite materials made of high-modulus or ultrahigh-modulus carbon fibers are unsuitable for production of components under pressure stress because the pressure stress of these composite materials is much smaller compared to composite materials of glass fiber or high-strength (HT) carbon fibers.

By way of comparison, table 1 shows the different strengths of various UD layers in comparison:

TABLE 1

| | Compressive | Shear | Tensile |
|---|---|---|---|
| Fiber | strength | strength 12 | strength |
| Glass fiber | 670 MPa | 80 MPa | 1100 MPa |
| epoxide UD | | | |
| HT carbon fiber | 1000 MPa | 60 MPa | 2230 MPa |
| epoxide UD | | | |
| UHM carbon fiber | About 200 MPa | Not known | 1800 MPa |
| epoxide UD | | exactly | |

It has now been found that, surprisingly, high-modulus carbon fibers—carbon fibers with 300 to 500 GPa—and ultrahigh-modulus carbon fibers—carbon fibers with more than 500 GPa—in spite of their low strength, especially compressive strength and/or shear strength, are suitable for use in tubes under pressure stress, especially also of cans of electric motors, because only slight component stresses occur in these tubes or components until shortly before occurrence of warpage failure of the tube/component. Carbon fibers are notable for high strength and stiffness. High-modulus fibers have comparatively low breaking strength. This is attributable to the alignment of the basal plane in fiber direction. The covalent C—C bonds are thus enormously strong in fiber direction.

High-modulus and ultrahigh-modulus carbon fibers show extremely high stiffness. Since the warpage point of warping structures depends on material stiffness among other factors, it is thus possible with this material class to achieve otherwise unattained warpage pressures, even though, as already mentioned, compressive strength is only very low by comparison; for example by comparison:
Modulus of elasticity of UHM carbon fibers: 500 GPa to 935 GPa (in fiber direction), especially 600 to 800 GPa—e.g. Mitsubishi K13D2U—
Modulus of elasticity of an HM carbon fiber: 300 GPa to 500 GPa
Modulus of elasticity of steel: 200 GPa
Modulus of elasticity of standard HT carbon fibers: less than 300 GPa, especially 230 GPa (in fiber direction)
Modulus of elasticity of glass fibers: 70 GPa (in fiber direction)

UHM carbon fiber-reinforced composite materials are used militarily and/or in aerospace, the exact applications being unknown. They are also used for reinforcement of steel supports in bridges because their extremely high modulus enables reduction of the load of the steel supports. This mechanical use is restricted to the side of the steel supports under tensile stress.

The HM/UHM reinforcing fibers is the quite competitive material cost relative to many ceramic aluminum oxide fibers that are likewise very rigid. In the case of components under pressure stress, such as, in particular, a can of a liquid-cooled electric motor under external pressure, failure with a previous wavefront can be delayed by the use of ultrahigh-modulus carbon fibers for reinforcement of a composite material.

In some embodiments, the HM/UHM carbon fibers are used in the form of pitch-based fibers, especially in the form of hard coal tar pitch-based fibers. High-modulus (HM) or ultrahigh-modulus (UHM) carbon fibers, especially based on pitch, e.g. ultrahigh-modulus carbon fibers based on hard coal tar pitch, may be in elongated form, especially in longitudinally elongated form, in the composite material from which the cans, for example, have been made. In this case, not only may the HM/UHM fibers be “elongated”, with minimum undulation at a particular fiber angle, but also all other reinforcing fibers that are possibly present in the HM/UHM composite material and/or in the further composite material of the can. The fibers would stretch out for the first time in operation according to the load in order to bear loads.

A suitable matrix material in which the HM/UHM fibers are embedded for production of the HM/UHM composite material is virtually any of the standard thermosets—for example polyester, vinyl ester, polyurethane, epoxy resin, formaldehyde resin, melamine, polyimide, phenol and/or thermoplastics—e.g. polyethylene, polycarbonate, polystyrene, polyvinyl chloride, polyamide, acrylonitrile-butadiene-styrene, celluloid and/or ceramics—e.g. metal oxides such as corundum, aluminum oxide, titanium dioxide, silicon carbide, which are also commonly used in other known fiber-reinforced composite materials. Typically, thermosets are used. In some embodiments, particularly with the “ceramic” matrix material, it may be possible to produce even more rigid tubes because an HM/UHM fiber tube with a ceramic aluminum oxide matrix, by virtue of the stiff ceramic matrix, shows even higher warpage pressure rigidity than pipes with a polymeric matrix. However, a relatively high production complexity should be included in the calculation here.

It is also possible to use any desired combinations of matrix materials, provided that they are compatible. In addition, it is possible to use a matrix material with added filler and/or particles of any kind in order to achieve particular effects.

In some embodiments, a process for producing a can may include a winding process of embedding the HM/UHM fibers in the form of an endless roving—the term “roving” being known to the person skilled in the art from the textile sector—into a resin, then winding to form a tube on a carrier, especially a cylinder, for example a steel cylinder, and subsequently curing in an oven. The ready-cured tube is separated from the carrier and can then be used as can.

A further mode of production is prepreg technology. This involves impregnating fiber mats containing high-modulus and/or ultrahigh-modulus fibers with resin and cutting them to size. The blanks or laminates are then laid out on a carrier, for example a steel cylinder, preferably also laid out in multiple layers, and/or laminated and then cured again in an oven. Semifinished products exist here, in which there are unidirectional “UD” fibers or “UD” layers, i.e. “UD” fiber mats.

The two abovementioned production processes are useful in various use scenarios, with prepreg technology also being suitable for production of complex shapes. A further manufacturing process for production of a can is the resin infusion process. Dry weaves, or UD fiber mats stabilized with a base weave, are wound here in dry form on a steel cylinder and then resin is diffused into them, especially by impregnation and consolidation.

A UD fiber mat, or a unidirectional “UD layer”, here is the term for a layer and/or a fiber composite material in which it is assumed, in an idealized manner, that all fibers are oriented in a single direction. In real composite materials, however, there will always be defects. The fibers are ideally assumed to be parallel and homogeneously distributed. The unidirectional layer in this ideal case is transversally isotropic, but otherwise only approximately transversally isotropic. A UD layer, as fiber mat, is the main element of layered fiber composite materials.

In the HM/UHM fiber composite material, any desired combinations with further reinforcing fibers are possible and conceivable in the context of the invention, for example with glass fibers “GFR”, polymer fibers “PFR”—including all known nonconductive polymeric reinforcing fibers—ceramic fibers “KFR” and/or else other non-ultrahigh-modulus but merely, for example, only high-modulus carbon fibers “CFR”. The production of the combinations is known to the person skilled in the art from a multitude of processing operations on fiber composite materials.

Reinforcement in axial direction, in order to absorb possible loads, may be accomplished with electrically nonconductive fibers. UHM carbon fibers are commercially available and obtainable in extremely ultrahigh moduli, for example from Mitsubishi Chemicals. The teachings of the present disclosure may provide, in addition to the stability and stiffness of the cans with HM/UHM reinforcement, is the good heat capacity thereof.

The can may be manufactured wholly or partly from a fiber composite material comprising HM/UHM carbon fibers. The proportion by weight of HM/UHM fiber composite material in the can may be 50% by weight or higher. The remaining proportion by weight of 100% of the can is made up by one or more compatible composite materials, especially by further fiber-reinforced composite material, for example by glass fiber composite material, high-modulus carbon fiber composite material, carbon fiber composite material, or other compatible materials—for example glass fiber composite material and/or an aramid, polypropylene and/or polyethylene terephthalate fiber composite material.

This then results in material combinations of the can, which can be varied according to the field of use, size and power of the electric motor and market demands. In some embodiments, cans comprise at least 50% by weight, especially between 55% by weight and 99% by weight, especially between 70% by weight and 98% by weight, of HM/UHM fiber composite material comprising HM/UHM carbon fibers, with a typical fiber content in these HM/UHM fiber composite materials of more than 15% by weight.

However, the fiber content in the HM/UHM fiber composite material is typically measured in terms of percentage by volume, such that, for example, an HM/UHM fiber composite material of good usability has a proportion by volume of HM/UHM carbon fiber, based on 100% volume of the HM/UHM fiber composite material—i.e. based not on 100% by volume of the can but on 100% by volume of the HM/UHM composite material—in the range between 35% by volume and 80% by volume, between 37% by volume and 75% by volume, or between 40% by volume and 70% by volume, for example with a proportion by volume of 55% by volume, as a proportion by volume of HM/UHM fibers in the form of high-modulus or ultrahigh-modulus carbon fibers embedded into matrix.

A can produced in this way shows a comparatively high thermal conductivity in the order of magnitude of 80 to 200 W/mK parallel to the preferential fiber direction, or in circumferential direction in the case of winding of the can on a cylindrical carrier, still with a measurable thermal conductivity of 0.4 to 1.5 W/mK transverse to fiber direction, i.e. in axial and/or radial direction.

In this way, it is possible firstly to achieve a reduction in maximum component temperatures in the laminated stack, and, on the other hand, degradation of hotspots in the can is possible. The crucial difference from the known cans made of conventional fiber composite material is that an increase in efficiency of the cooling system is achieved by the controlled modification of the can or of the fiber material used therein. It has not been possible to date to use high-modulus or ultrahigh-modulus carbon fibers in cans owing to their intrinsic electrical conductivity for the reasons mentioned above. Carbon fibers in the form of high-modulus or ultrahigh-modulus reinforcing fibers do not show this disruptive conductivity in composite materials, but instead enable reduced component and/or can temperatures on the one hand and hence higher power densities and/or longer lifetimes by virtue of their extreme stiffness and their extremely high intrinsic thermal conductivity.

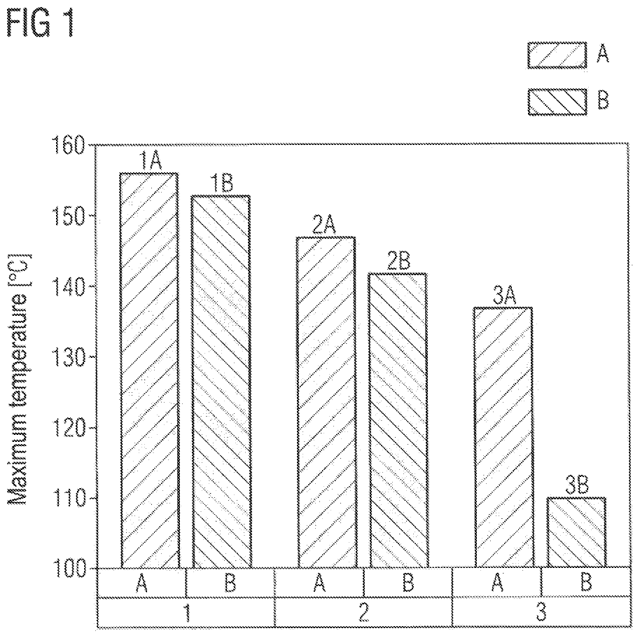

In tests and by way of evidence of this theory, the maximum temperatures of a conventional can were compared with a can incorporating teachings of the present disclosure. FIG. 1 shows the measured component temperatures in an electric motor. For the provision of evidence, thermal simulations were conducted, in which the resulting component temperatures in the coils, in the laminated stack and in the can were evaluated with variation of the thermal conductivity of the can material.

The comparative example used was a conventional can made of composite material or made of composite material reinforced with fibers of low thermal conductivity in the same electric motor; for this purpose, a typical thermal conductivity value for such composite materials of 0.2 W/mK, isotropic, was assumed. This was compared with an electric motor having a can incorporating teachings of the present disclosure made of at least 70% by weight of HM/UHM composite material—i.e. with high-modulus or ultrahigh-modulus carbon fiber reinforcement.

For this purpose, thermal conductivity values at the lower limit of the range of thermal conductivity tested for the cans of the invention were assumed. The assumed values were 84 w/mK in fiber direction and 0.4 w/mK transverse to fiber direction. In spite of the value set at the lower end of the values to be expected, the electric motor with the can of the invention made of UHM composite material already showed much lower maximum temperatures under otherwise the same conditions.

FIG. 1, even at these thermal conductivities set at a relatively low level in a can of the invention, shows much lower maximum temperatures in the system, i.e. in the can itself and also in the coil and laminated stack components of the electric motor. FIG. 1 shows, on the Y coordinate, the maximum temperatures in ° C., and on the x axis 3 pairs in each case with temperature bars. In each case, the left-hand bar “A” represents the prior art, always with higher maximum temperatures than the right-hand bar “B”, which represents an embodiment of the electric motor with a can made of a UHM composite material with at least a proportion of 70% by weight of UHM composite material.

The bar pairs 1 to 3 show, from left to right:
1—coil, 1A—prior art and 1B according to the invention
2—laminated stack, 2A—prior art and 2B according to the invention and
3—can, 3A—prior art and 3B according to the invention.

Compared to a conventional design, the higher the thermal conductivity of the can 3B, the greater the decrease in temperature will be. For example, with ultrahigh-modulus carbon fibers, it is possible to achieve thermal conductivities of more than 150 W/mK in fiber direction and 1.5 W/mK transverse to fiber direction. According to these tests, these then suggest even higher decreases in temperature in the electric motor.

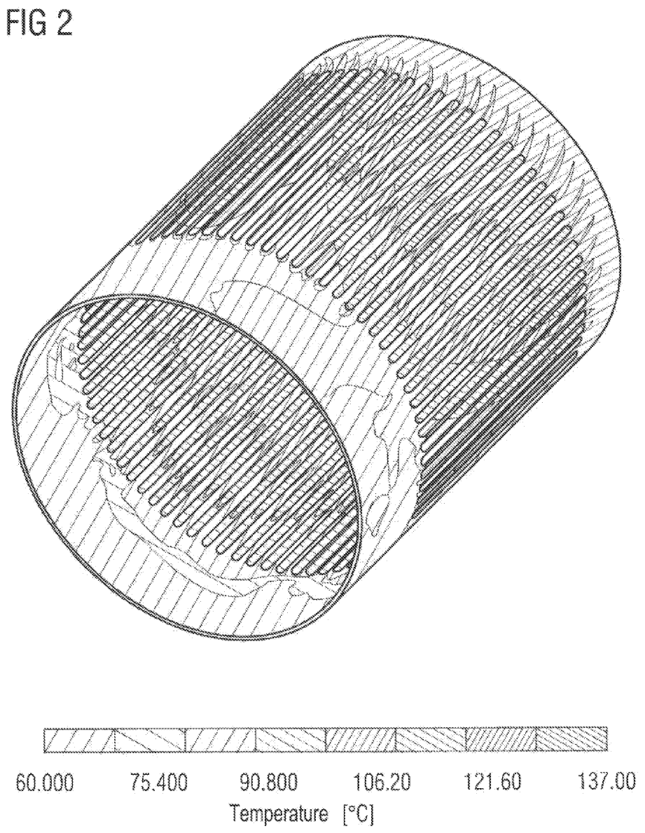

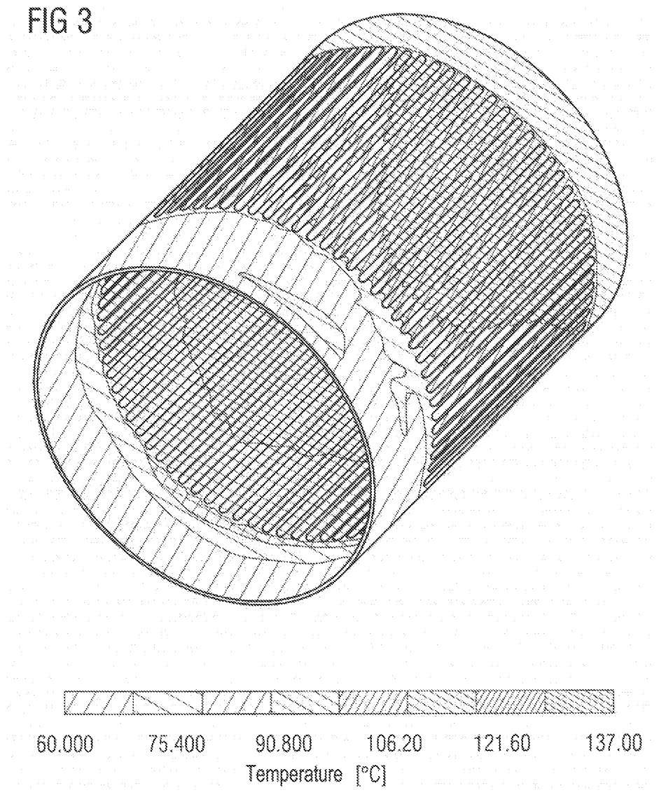

In further tests, the temperature distribution in the can was evaluated from this study—FIG. 1. FIG. 2 shows a conventional can 3A according to the prior art, and FIG. 3 shows a can 3B incorporating teachings of the present disclosure.

FIG. 2 shows how hotspots present in the can 3A, which often occur in the region of the teeth of the laminated stack, form discrete structures and discrete regions with extreme thermal stresses. By contrast, the can 3B shows how, as a result of the high thermal conductivity of the composite material of the can, hotspots are degraded and homogenized over the entire component volume.

This distinct reduction in maximum can temperatures suggests a higher durability/lifetime of the can and hence enables the use of less expensive materials in a component development process on account of reduced demands on thermal stability.

The present disclosure relates to a canned electric motor or a liquid pump. The present invention for the first time, through the use of HM/UHM composite materials for production of cans, shows that it is possible to overcome the scientific prejudice that carbon fibers are generally unsuitable as fiber reinforcement in composite materials for the production of cans on account of their intrinsic electrical conductivity. Instead, what is shown by the present disclosure is what great benefits the use of high-modulus or ultrahigh-modulus carbon fibers bring with regard to heat capacity and/or warpage resistance in what are called HM/UHM composite materials, on their own or in material combinations with further composite materials, in the production of cans.

What is claimed is:

1. A canned electrical rotating machine or liquid pump comprising:
a can made of first material;
wherein the first material comprises, at least in a proportion of more than 50% by weight, a composite material with high-modulus or ultrahigh-modulus (HM/UHM) carbon fiber reinforcement.

2. The canned electrical rotating machine or liquid pump as claimed in claim 1, wherein the carbon fiber reinforcement includes HM/UHM carbon fibers in elongated form.

3. The canned electrical rotating machine or liquid pump as claimed in claim 1, wherein the HM/UHM carbon fibers reinforcement are at least partly in a layer.

4. The canned electrical rotating machine or liquid pump as claimed in claim 1, wherein the HM/UHM carbon fibers are at least partly in unidirectional form.

5. The canned electrical rotating machine or liquid pump as claimed in claim 1, wherein the HM/UHM carbon fibers are at least partly in the form of an endless roving.

6. The canned electrical rotating machine or liquid pump as claimed in claim 1, wherein the HM/UHM carbon fibers are at least partly in the form of pitch-based fibers.

7. The canned electrical rotating machine or liquid pump as claimed in claim 6, wherein the pitch-based HM/UHM carbon fibers are at least partly in the form of hard coal tar pitch-based HM/UHM carbon fibers.

8. The canned electrical rotating machine or liquid pump as claimed in claim 1, wherein the matrix material present in the HM/UHM composite material is a thermoset.

9. The canned electrical rotating machine or liquid pump as claimed in claim 1, wherein the composite material includes a thermoplastic matrix material.

10. The canned electrical rotating machine or liquid pump as claimed in claim 1, wherein the composite material includes a ceramic matrix material.

11. The canned electrical rotating machine or liquid pump as claimed in claim 1, wherein the HM/UHM carbon fibers are present in a range from 35% to 80% by volume.

12. The canned electrical rotating machine or liquid pump as claimed in claim 1, wherein the can further comprises a glass, an aramid, a polymer, and/or a ceramic fiber composite material.

13. The canned electrical rotating machine or liquid pump as claimed in claim 1, wherein the can further comprises an aramid, a polypropylene and/or a polyethylene terephthalate fiber composite material.

14. The canned electrical rotating machine or liquid pump as claimed in claim 1, wherein the can further comprises a polypropylene fiber composite material.

15. The canned electrical rotating machine or liquid pump as claimed in claim 1, wherein the can comprises a polyethylene terephthalate fiber composite material.
